(19) United States
(12) Patent Application Publication
(10) Pub. No.: US 2022/0050194 A1
(43) Pub. Date: Feb. 17, 2022

(54) MOTION SENSING PUSHBUTTON STATION

(71) Applicant: POLARA ENTERPRISES, LLC, GREENVILLE, TX (US)

(72) Inventors: Ryan Macias, Greenville, TX (US); Chris Tisone, Greenville, TX (US)

(73) Assignee: Polara Enterprises, LLC, Greenville, TX (US)

(21) Appl. No.: 17/400,069

(22) Filed: Aug. 11, 2021

Related U.S. Application Data
(60) Provisional application No. 63/064,727, filed on Aug. 12, 2020.

(51) Int. Cl. G01S 13/56; G01S 7/02

(52) U.S. Cl. CPC G01S 13/56; G08G 1/005; G01S 7/027

(57) ABSTRACT

A pushbutton station is provided including a user selectable pushbutton, a housing, a radar sensor module supported by the housing operable to detect motion occurring within a detection zone, and a controller configured to receive an electronic communication transmitted from the radar sensor module. Upon receipt of the electronic communication, the controller is configured to effectuate user selectable pushbutton functionality without the selectable pushbutton having been physically selected.

The present application claims priority based on U.S. Provisional Patent Application Ser. No. 63/064,727, entitled “Motion Sensing Pushbutton Station,” inventors Ryan Macias, et al., filed Aug. 12, 2020, the entirety of which is incorporated herein by reference.

### BACKGROUND OF THE INVENTION

### Field of the Invention

The present disclosure relates generally to the field of button actuated devices, and more particularly, to systems and methods that would facilitate and benefit from touchless activation in addition to having a physical button. The touchless activation may generate an event, actuate a switch, or provide a contact closure. Such touchless activation may be used by a person wishing to open a door, start an event, call an elevator, cross a street at a traffic signal controlled intersection, or other similar events.

### Description of the Related Art

Most buildings have elevators that are called and doors that are actuated by buttons that are physically pushed, which requires a person to physically touch the button. For example, physical buttons are used for wheelchair access doors, doors in hospitals, elevator call buttons, and the like.

Most metropolitan areas in the United States and elsewhere have intersections controlled by traffic lights. These intersections are also typically equipped with pedestrian push buttons that are physically pushed to activate Walk/Don't Walk signals or non-verbal symbols displayed in a pedestrian signal head, also referred to as a ped head, to visually indicate when the vehicular traffic is signaled to stop, such that a walk phase is in effect. During a walk phase, a traffic controller of the intersection, signals the traffic signals to direct traffic to stop and the ped head displays the walk signal for the particular crosswalk for a predetermined period of time.

For the visually impaired, it is necessary to have other means of indicating when a walk phase is in effect. Accessible Pedestrian Signals (“APS”) provide an audio and/or a vibro-tactile indication to the visually impaired pedestrian that the traffic control signals are in a walk phase and the ped head is displaying a walk signal. The APS provides the visually impaired pedestrian, through a tactile and audible format, the same information a sighted pedestrian has via signs and lights.

The APS may emit a periodic location tone to guide a visually impaired pedestrian to the APS, so that a walk phase request, also referred to as a walk request, can be made. The APS may also have a tactile directional arrow that points in the direction of the crosswalk. The APS may also provide an audio message indicating that the ped head is displaying the walk sign and a walk phase is in effect. Certain APSs may optionally give information about the street being crossed. An APS may also be equipped with an LED that lights when the button is pushed. When the walk phase is in effect the button of the APS may vibrate for the full duration of the walk phase. Upon reaching the clearance phase, the vibration stops and optionally a countdown message may be played. Alternatively, the APS may return to emitting the location tone.

According to certain embodiments, the APS may facilitate an extended push priority to allow a visually impaired pedestrian to hold the button to increase the volume and silence audible signals of other APSs. Examples of such APS systems are described in U.S. Pat. No. 7,145,476 and U.S. Patent App. Pub. No. 2016/0267787, the disclosures of which are incorporated herein by reference.

A visually impaired person can approach a push button station that is typically supported by a pole located at a street intersection. The pushbutton station is located at a generally known height on the pole above the street that is convenient for a pedestrian to reach the button. Currently the pedestrian depresses a button on the pushbutton station to register a request for a walk phase for the particular crosswalk associated with the pushbutton station. Upon pressing the button, the pedestrian, particularly a visually impaired pedestrian, requires a signal to know that the walk request was registered and when the walk phase is in effect, so the visually impaired pedestrian may cross the street.

A variety of switches have been employed in connection with a depressible button to communicate the signal to a central control unit or traffic controller to request the walk phase. For example, mechanical contact switches are actuated to close a normally open circuit and short a voltage to ground, or open a normally closed circuit to allow current to flow. In either case, the central control unit or traffic controller is signaled that the button has been physically pressed by a pedestrian. Piezoelectric switches have also been used because of their improved reliability over mechanical switches, in that they can be cycled more times than mechanical switches without wearing out. An example of a piezoelectric switch is described and claimed in U.S. Pat. No. 6,340,936, which is hereby incorporated by reference. A Hall effect switch has been coupled to a button of a pushbutton station. The Hall effect switch brings a magnet within a predetermined distance of a Hall effect sensor to create a voltage drop across the Hall effect sensor, and this voltage drop will cause the walk request to be registered. A Hall effect switch is shown and described by U.S. Patent No. 2016/0172136, which is hereby incorporated by reference. Other switch activation methods are contemplated by the present disclosure.

It may be desirable for all pedestrians, to register a walk request without touching anything. For example, a smart phone, an RFID emitter, or other communication device may be recognized by a sensor associated with the pushbutton station. However, this arrangement requires a set up procedure to allow the sensor to recognize the personal communications device of the pedestrian. It may be desirable for the pedestrian to actuate a button of a pushbutton station without a preliminary setup procedure or depressing a button.

### SUMMARY OF THE INVENTION

According to one embodiment, there is provided a pushbutton station, comprising a user selectable pushbutton, a housing, a radar sensor module supported by the housing operable to detect motion occurring within a detection zone, and a controller configured to receive an electronic communication transmitted from the radar sensor module. Upon receipt of the electronic communication, the controller is configured to effectuate user selectable pushbutton functionality without the selectable pushbutton having been physically selected.

According to a further embodiment of the present design, there is provided a pushbutton station, comprising a user selectable pushbutton, a sensor operable to detect motion occurring within a detection zone, and a traffic controller associated with a traffic controlled intersection, the traffic controller configured to receive an electronic communication transmitted from the sensor module. Upon receipt of the electronic communication, the controller is configured to effectuate user selectable pushbutton functionality without the selectable pushbutton having been physically selected.

According to another embodiment of the present design, a pushbutton station may be provided, comprising a user selectable pushbutton, a sensor module operable to detect motion occurring within a detection zone comprising an area a predetermined distance from the sensor module, and a controller configured to receive an electronic communication transmitted from the sensor module. Upon receipt of the electronic communication, the controller is configured to effectuate functionality of the user selectable pushbutton without the selectable pushbutton having been physically selected.

An additional embodiment of the present design relates to a pushbutton station that includes a housing that supports a radar sensor module. The radar sensor module is operable to detect motion occurring within a detection zone. Detection of the motion causes a signal to be sent to generate an event, or actuate a device. According to certain embodiments, the signal is sent to a central control unit, or the traffic controller of a traffic signal controlled intersection to request a walk phase. The motion may be movement of a hand or other body part of a user, or may be a cane, a wheelchair, or other device used by a user within the detection zone.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a schematic illustration of a traffic signal controlled intersection employing motion sensing pushbutton stations according to embodiments of the present disclosure;

FIG. 2A is a block diagram showing internal components of a motion sensing pushbutton accessible pedestrian signal (APS) station according to embodiments of the present disclosure;

FIG. 2B is a block diagram showing internal components of a general purpose motion sensing pushbutton station according to embodiments of the present disclosure;

FIG. 3 is a schematic showing certain detection zones of a motion sensing pushbutton station according to embodiments of the present disclosure; and

FIG. 4 is an exploded, perspective view of a motion sensing APS pushbutton station according to an embodiment of the present disclosure.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

The present disclosure is directed to a pushbutton station activated by a touchless gesture or other motion of a user that is recognized by the pushbutton station. In response to such recognition, the pushbutton station may: cause a door to unlock or open or both, call an elevator, register a walk phase request, and the like. According to one embodiment, the gesture or other motion recognition of the user causes a signal to be communicated to a central control unit or traffic controller indicating that a walk phase is desired for a particular street or crosswalk. The central control unit or traffic controller then initiates a sequence that causes a requested event to occur, door to open, door to unlock, or a traffic signal controller to stop traffic along the street that has been indicated as desired to cross, and initiate a walk event to allow the pedestrian to cross.

A pushbutton station employing a motion sensor module to allow touchless activation of the switch may be particularly beneficial to prevent the spread of communicable diseases because individuals can activate a button without touching it and risking transmission of bacteria or viruses. Also, because a button would not need to be touched by the general public in order to activate a traffic signal, open a door, turn on a light, call an elevator, and the like, the motion sensor would reduce the likelihood of transmitting disease.

According to certain embodiments, the sensor is a radar transceiver that is operable to detect motion in a particular zone associated with the emission of an electromagnetic wave, particularly an electromagnetic microwave, also referred to herein as radar. An LED may also be illuminated so the pedestrian knows that the motion was detected, the walk phase request has been sent, and the central control unit is initiating the traffic control sequence associated with the walk phase for the particular crosswalk. The audio may also indicate when a walk phase or a clearance phase is in effect. For example, a verbal countdown of seconds remaining to cross the street may be played. According to an alternate embodiment, the clearance phase may be associated with a location tone. This may be particularly useful for crossing a street with multiple lanes where crossing, particularly for a visually impaired or mobility impaired person, may take a significant amount of time to completely cross.

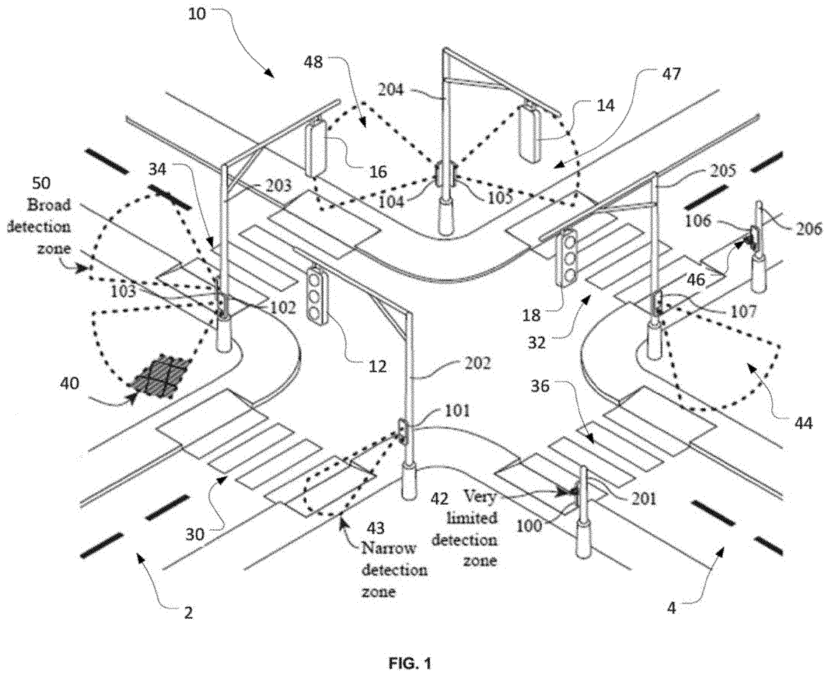

FIG. 1 depicts a traffic light controlled intersection 10 where each street is a two lane roadway permitting vehicular traffic flow in opposite directions. A pedestrian may be walking along a street 2 toward the intersection 10, and to continue to his destination, the pedestrian must cross a street 4 that intersects with the street 2 at a crosswalk 36. The pedestrian approaches a pedestrian pole 201 to which a pushbutton station 100 is mounted at an appropriate height. The pushbutton station 100 is oriented so that a pedestrian facing the pushbutton station 100 can turn 90° toward the intersection and cross the street 4. The pedestrian may activate the pushbutton station 100 in a variety of manners. For example, the pedestrian may reach out to depress the button portion of the pushbutton station 100. The button portion may include a raised arrow that a visually impaired person can feel that indicates the direction of the crosswalk 36 associated with that particular pushbutton station 100.

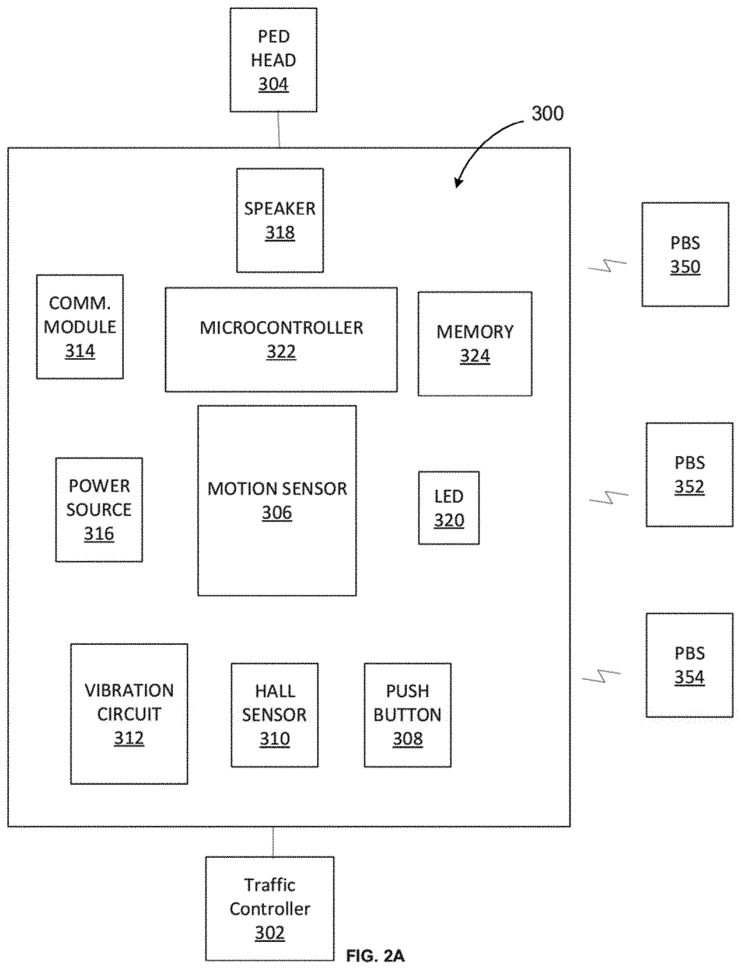

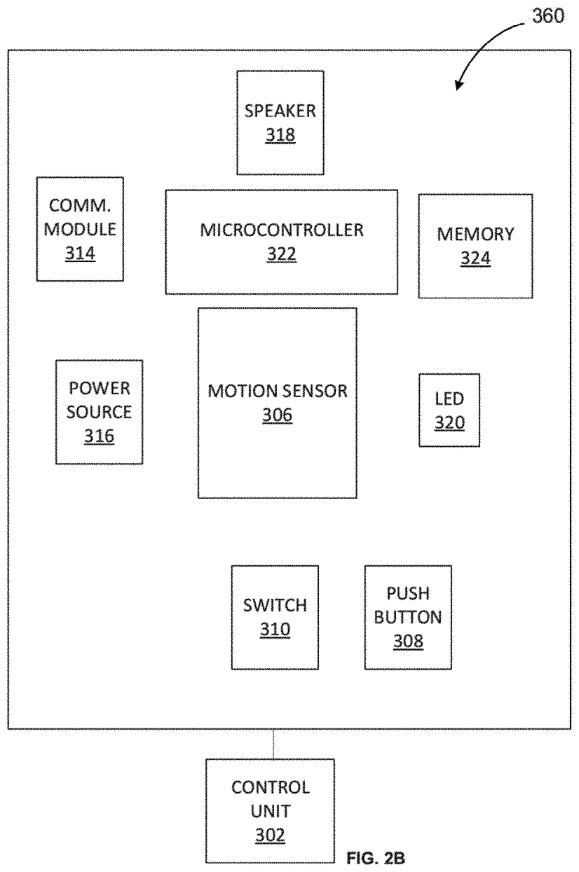

According to another embodiment, the pedestrian may activate the pushbutton station 100 without touching the button at all. The pedestrian may make a gesture, such as a hand wave within a detection zone 42 of the pushbutton station 100. The detection zone 42 may be created by emission of a radar wave that is generated by internal circuitry housed in a housing of the pushbutton station 100, as described in further detail with respect to FIG. 2A. The motion of the pedestrian's hand within the detection zone 42 is detected by the circuitry of the pushbutton station 100 as reflected radar waves indicating that the pedestrian desires to activate the pushbutton station 100 such that the pushbutton station 100 sends a walk phase request to a central control unit or traffic controller (not shown in FIG. 1). A signal is sent to the central control unit or traffic controller to initiate the sequence that causes a traffic signal 16 and a traffic signal 18 to illuminate a yellow light and then subsequently a red light to stop the vehicular traffic on the street 4. The pushbutton station also receives a signal from a control unit, traffic controller, or ped head (not shown in FIG. 1) indicating that the walk sign is illuminated and a walk phase is in effect. This signal causes an audio speaker within the pushbutton station 100 to play an audio message (i.e. play a prerecorded audio file) indicating to the pedestrian that the walk phase is in effect. The audio file directing the pedestrian to walk may play for a predetermined period of time corresponding to the time the walk sign in the ped head is illuminated during the walk phase.

The pedestrian then can approach a pedestrian pole 206 on which is mounted a pushbutton station 106. The pushbutton station 106 operates in the same manner as the pushbutton station 100 described above. Thus, when the user depresses a button on the pushbutton station 106 or makes a hand motion or other gesture within a detection zone 46, the signal is sent to the central control unit or traffic controller indicating that the user wishes to cross the street 2 using a crosswalk 32. The audio file and the vibration of the pushbutton station 106 is initiated as described above with respect to pushbutton station 100. The visually impaired pedestrian is audibly notified that a walk phase is in effect, and the vehicular traffic on the street 2 has been signaled to stop by a traffic signal 12 and a traffic signal 14.

A pedestrian may approach a pushbutton station 102, which is mounted to a traffic signal pole 203, by walking along the street 2. The pedestrian may stop in or walk through a detection zone 40 of the pushbutton station 102. The detection zone 40 may be controlled and configurable for the particular application, such as detection of a particular area proximate a the crosswalk 30. The traffic signal pole 203 may also have a pushbutton station 103 mounted perpendicularly to the pushbutton station 102 which is associated with crossing the street 4 using the crosswalk 34. The pushbutton station 102 emits a radar wave directed to the detection zone 40 and reflects off of a pedestrian, for example a visually impaired pedestrian, desiring to cross the street 2. Alternatively, the pedestrian may depress a button on the pushbutton station 102 to indicate that the pedestrian wants to cross the street 2. Upon detection of motion of the pedestrian in the detection zone 40, the internal circuitry of the pushbutton station 102 determines that the pedestrian wants to cross the street 2. A signal is sent to the central control unit to initiate the red light sequence of the traffic signal 12 and the traffic signal 14 to stop the vehicular traffic along the street 2 to allow the pedestrian to cross the street 2.

The push button station 102, depending on the APS, may also receive a signal from a ped head that the walk sign is illuminated and a walk phase is in effect. This signal causes an audio file to play from the pushbutton station 102 to inform a visually impaired pedestrian that the walk phase for the street 2 is in effect.

The detection zone 40 may be adjusted by adjusting particular parameters of the radar transceiver disposed within the housing of the pushbutton station 102, as described in further detail below. For example, the detection zone 40 may be adjusted such that the radar signal is transmitted and reflected from a detection zone that is larger than the detection zone 43, as shown by the broken lines illustrating broad detection zone 50, which is associated with a pedestrian desiring to cross the crosswalk 34. A pushbutton station 104 is supported by the traffic pole 204 to facilitate the crossing of a pedestrian, particularly a visually impaired pedestrian, across the crosswalk 34. The pushbutton station 104 is associated with a detection zone 48. A pushbutton station 105 is supported by the traffic pole 204 and has a detection zone 47. A pushbutton station 101 is supported by traffic signal pole 202 and has a detection zone 43.

Reference is made to FIG. 2A, which is a schematic diagram of an APS pushbutton station 300, which may be any one, some or all of the pushbutton stations 100-107 illustrated in FIG. 1. The components of the APS pushbutton station 300 shown in FIG. 2A may be housed in a housing formed of a polymeric material. Alternatively, the components of the APS pushbutton station 300 may be contained in a housing formed of primarily a metallic material, such as sheet metal. At least a portion of the housing is formed of polymeric material or glass to allow the radar waves to be emitted and received through the polymeric or glass portion of the housing.

Certain components illustrated in FIG. 2A may be supported by one or more printed circuit boards. As discussed above with respect to FIG. 1, the APS pushbutton station 300 is in communication with a central control unit or traffic controller 302. The central control unit or traffic controller 302 may be a separate control unit connected to the intersection traffic controller, or it may be the traffic controller itself that controls the traffic and pedestrian signal heads of a traffic signal controlled intersection, such as the traffic signal controlled intersection 10 shown in FIG. 1. The central control unit or traffic controller 302 may be housed in a traffic cabinet. The APS pushbutton station 300 is also in either wired or wireless communication with multiple other pushbutton stations 350, 352, 354, and so on. For example, the multiple pushbutton stations shown and described with respect to FIG. 1 may be in wireless communication with each of the other pushbutton stations. The pushbutton station 300 may be in wireless or wired communication with any of up to 20 pushbutton stations employed in a particular intersection. According to one embodiment, the pushbutton station 300 may be in wired or wireless communication with one or more ped heads 304. The ped head 304 provides visual indication of a walk or don't walk signal or similar non-verbal symbols understood by a sighted pedestrian. The ped head 304, or the voltage that operates the ped head, also signals the pushbutton station 300 to play an audio message and/or vibrate a button to indicate to the visually impaired pedestrian that a walk phase is in effect.

The internal components of the APS pushbutton station 300 includes a radar motion sensor 306, also referred to as a radar sensor module or sensor module. The radar motion sensor 306 may be Doppler, continuous wave, or other Radar type. The radar sensor module 306 may emit an electromagnetic microwave in the 20 GHz to 85 GHz range. The sensor module 306 may have an adjustable antenna to adjust the detection zone, specifically a distance from the sensor module 306, within which pedestrian motion can be detected. The radar sensor module 306 is operable to detect low speed motion at short distances, compared to other radar applications, such as detecting the speed of a moving baseball pitch or automobile speed. The radar sensor module 306 may have a microwave circuit with an operating frequency in a range of 20 GHz to 85 GHz, for example 24 GHz operating frequency. The radar sensor module 306 is operable to detect the motion of the pedestrian in the detection zone. In certain embodiments, the sensor module 306 is operable to detect whether the pedestrian is moving toward, across, or away from the radar sensor module 306. In a further alternate embodiment, the radar sensor module 306 may detect separation among multiple pedestrians. In other words, the radar sensor module 306 detects if there is more than one pedestrian moving within the detection zone. The radar sensor module 306 may include internal components, such as an antenna, a signal processing circuit, an intermediate frequency amplifier, a voltage regulator, and a microcontroller.

The Radar sensor 306 may operate in multiple modes depending on the settings of the module. For example, the radar sensor module 306 may operate in a digital or analog mode. The radar sensor module 306 may operate continuously or intermittently. According to certain embodiments, the radar sensor module 306 may operate in a low power consumption mode and/or a sleep mode for reducing power.

The radar sensor module 306 may also disregard certain noise that might otherwise be detected as pedestrian motion within the detection zone. For example, the radar sensor module 306 may detect and disregard motion that might include a plant leaf blown by the wind or rain drops. The radar sensor module 306 may include processing software to enhance certain sensing functionality. For example, the signal processing software may enhance the reflected signal from a moving object and thereby decrease the possibility of detection of random noises or events.

The signal processing software may also decrease the mutual interference among multiple sensors, as might be found in the pushbutton stations of the intersection 10 depicted in FIG. 1. The signal processing software may also be employed to identify a direction of movement of an object, such as a pedestrian, within the detection zone. For example, the signal processing software may be employed to detect whether a pedestrian is approaching the radar sensor module 306 or leaving/moving away from the radar sensor module 306. The radar sensor module 306 may also include multiple selectable antenna types.

The detection zone may have a distance from the radar sensor module 306 and the pushbutton station in a range of zero to six inches. The detection zone may be selected to allow a pedestrian to perform a hand gesture sufficiently close to any one of the APS pushbutton station 300, and thus sufficiently close to the radar sensor module 306 to be detected, without detecting a gesture of the pedestrian that is not intended to request a walk phase. According to other embodiments, the detection zone may be zero to two inches from a surface of the APS pushbutton station 300. Alternatively, the detection zone may be zero to five inches in front of a surface of the APS pushbutton station 300.

According to certain embodiments, the APS pushbutton station 300 includes a depressible button 308. When a pedestrian presses and displaces the button 308, a signal is generated that is recognized or registered as a request for a walk phase to the central control unit 302 of a traffic signal controlled intersection 10 to allow the pedestrian to cross the street. The button 308 may be a mechanical switch that upon displacement closes a circuit and sends the signal. Alternatively, the pushbutton 308 may be a piezoelectric device that generates a signal upon receiving pressure generated by the pedestrian pushing the button 308. In a further alternative embodiment as shown in FIG. 2, the displacement of the button 308 may be detected by a Hall effect sensor 310 to register the walk request of the pedestrian. According to certain embodiments, the pushbutton 308 may be vibrated by a button vibration circuit 312.

The pushbutton station 300 also includes a wireless communication module 314. The wireless communication module 314 may receive any type of wireless communication protocol, for example Bluetooth, Bluetooth Low Energy (BLE), Wireless LAN (WIFI), Zigbee, radio, cellular, NFC, and the like. The wireless communication module 314 allows the pushbutton station 300 to communicate wirelessly with a traffic controller, central control unit, other pushbutton stations 350, 352, 354, and with other wireless devices, such as a laptop computer, notebook computer, or smart phone of an installer when setting the parameters of the pushbutton station 300 or other pushbutton stations of the particular intersection upon installation.

The pushbutton station 300 also includes a power source 316. The power source 316 may be a battery or driver that provides power to the components of the pushbutton station 300. According to certain embodiments, the power source 316 may be electrically coupled to an existing power supply through a wired connection where the existing power supply provides power to multiple of the devices of the intersection 10. The pushbutton station 300 also includes a speaker 318. The speaker 318 plays an audio message, which may be embodied in a digital audio file. The speaker 318 may be one or more speakers oriented to project the audio message to a pedestrian standing near the pushbutton station 300 having just activated the pushbutton station 300 using a hand gesture recognized by the radar motion sensor 306 or depressing the pushbutton 308.

According to certain embodiments, the pushbutton station 300 also includes a light emitting diode (LED). The LED may be a red LED 320 that illuminates upon the detection of motion within the detection zones, by the radar motion sensor 306 or the pressing of a pushbutton 308. The LED 320 may indicate to a sighted pedestrian that the request to traverse the street has been registered by the pushbutton station 300 and the walk phase request has been sent to the central control unit 302. Alternatively, an audible signal or other visual signal may be used in addition to or in lieu of an LED.

The communication and signal generating and receiving by and among the components shown and described in pushbutton station 300, and with the central control unit 302, the ped head 304, and the other pushbutton stations may be controlled by the microcontroller 322. The pushbutton station 300 may also include a memory module 324.

The hardware and data processing components used to implement the various processes, operations, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. Uses of terms such as components, modules, and so forth herein are intended broadly to cover any logical arrangement of hardware, and such hardware may be produced in any manner by any entity, including by a manufacturer/vendor or alternately by a third party component or module fabricator wherein such hardware is incorporated into an end product produced and sold by an end product manufacturer/vendor.

In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

According to certain embodiments, the pushbutton station 300, and specifically the radar sensor module 306, may be employed to detect and count pedestrian traffic at a particular intersection for purposes of city planning or other applications of such data collection. Also, the pushbutton station 300 and more particularly the radar motion sensor 306, may be employed to sense and track weather events, such as rain, strong winds, tornadoes, and the like, which may be detected by the radar motion sensor 306, and this detection may be used to provide a warning or alert. The APS pushbutton station 300 optionally includes a microphone.

Reference is made to FIG. 2B, which is a schematic block diagram of a motion sensing pushbutton station 360 according to an embodiment of the present disclosure. The pushbutton station 360 is a general purpose pushbutton station, and thus certain components of the APS pushbutton station described above may be omitted, such as the vibration circuit. The components of the pushbutton station 360 shown in FIG. 2B are as described above with respect to FIG. 2A.

According to certain embodiments, the radar motion sensor 306 of the pushbutton station 360 may be employed with other types of actuators. For example, an activation button used to open a door for a mobility impaired individual may include a radar motion sensor 306 to allow activation of the button without requiring it to be depressed or even touched. Other types of buttons or activation switches that are conventionally activated by pressing may include the radar motion sensor 306 according to embodiments of the present disclosure. For example, certain doors within a medical facility, such as a hospital, may be unlocked and/or actuated using a push button placed on a wall or other structure proximate the door. The pushbutton station 360 may replace this type of push button and employ a radar motion sensor 306. The radar motion sensor 306 may be positioned approximately four to six feet, for example about 5 feet above the ground to allow a user to easily actuate it with a hand gesture, as opposed to depressing the button. According to certain embodiments, the detection zone may be adjusted by angling the radar motion sensor left/right or up/down. Detection zones up to 30 feet from the APS pushbutton station 300 are contemplated by this disclosure.

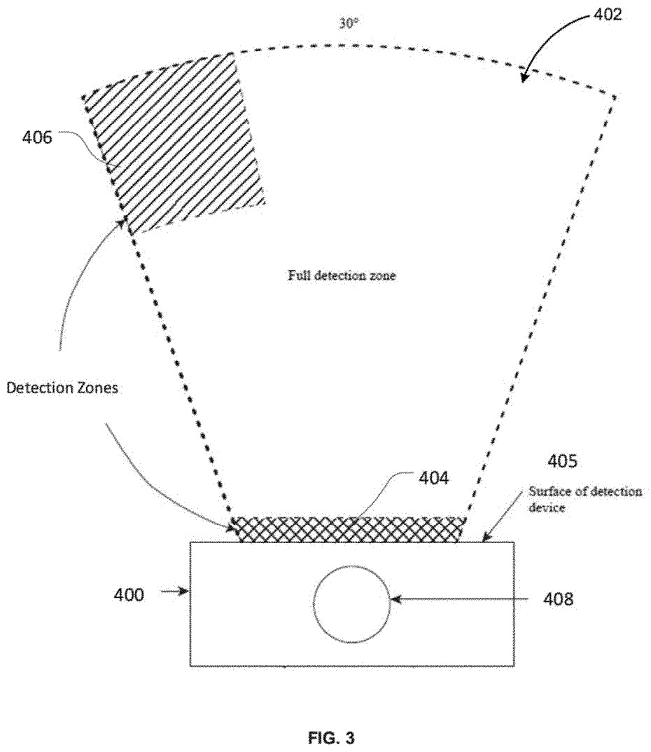

Reference is made to FIG. 3, which is a schematic showing different controlled and configurable detection zones of a pushbutton station 400 according to embodiments of the disclosure. The pushbutton station 400 may be similar to that described above with respect to FIGS. 1 2A, and 2B. The radar range 402 shown by the broken lines may designate a specific field of view, for example approximately 30°. The radar range 402 may be the full possible range of the radar motion sensor 306. The full range of the radar motion sensor may be up to thirty feet from the face 405 of the pushbutton station 400. The radar range 402 may have particular areas that are set through the programming of the radar motion sensor 306 to have specific detection zones as described above with respect to FIG. 1. For example, a close range detection zone 404 is shown a close distance from a surface 405 of the pushbutton station 400. For example, the detection zone 404 may extend a range of, for example, zero to six inches from the surface of the pushbutton station 400. According to an alternate embodiment, a detection zone 406 may be remote and at a longer range from the pushbutton station 400. Motion of a pedestrian in the detection zone 406 that is performed by a pedestrian at a particular location near a crosswalk, for example the crosswalk 30 as shown in FIG. 1 may be detected by the radar motion sensor of the pushbutton station 400. According to a further alternate embodiment, the detection zone may extend zero to approximately six feet from the face 405 of the pushbutton station 400. Long range detection zones, for example zero to thirty feet from the face 405 of the pushbutton station 400 may be employed to detect bicycle traffic in a bicycle lane proximate the pushbutton station 400.

The detection zone 406 may be selected by programming the radar motion sensor 306 or by other external processing. The pushbutton station 400 also includes a depressible button 408 that functions as described and shown with respect to the depressible button 308 shown in FIG. 2. The depressible button 408 may be located on the same side as the surface 405 of the pushbutton station 400 through which the radar is emitted, or any surface/side other than the surface 405. As described above, according to certain embodiments, detection of pedestrian motion within the close range detection zone 404, the long-range detection zone 406, or anywhere in the full range of the radar motion sensor is determined by the pushbutton station 400 to be a walk request for a crosswalk of a traffic controlled intersection 10. The pushbutton station 400 may also alert the pedestrian that the walk phase is in effect via audio and vibrotactile signals.

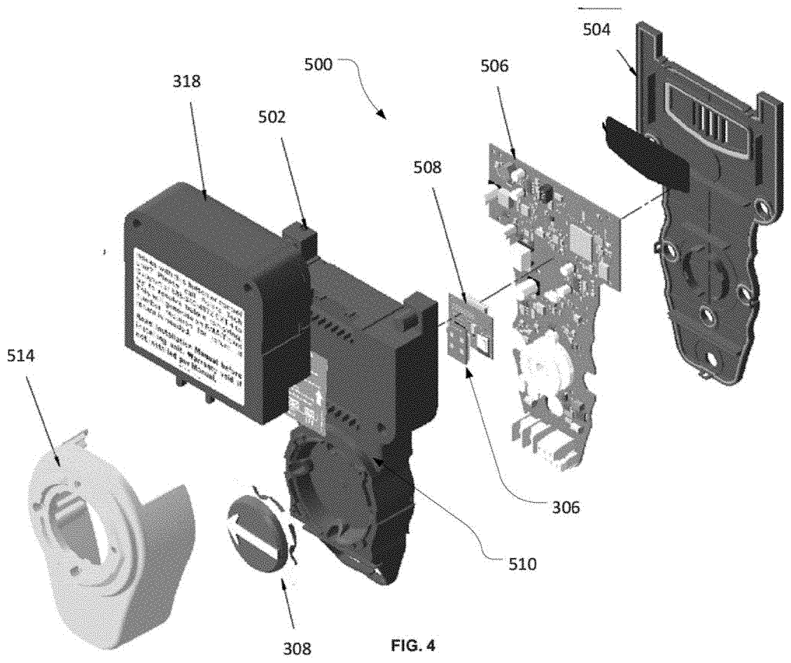

Reference is made to FIG. 4, which is an exploded perspective view of an APS version of a pushbutton station 500. The pushbutton station 500 may be employed and function as described above with respect to FIGS. 1-3. The pushbutton station 500 includes a housing 502. The housing 502 may be formed of a rigid polymeric material, such as polycarbonate, acrylic, or other similar materials. According to one embodiment, the housing 502 is a thin-walled polymeric part formed by injection molding or other polymeric forming processes. The housing 502 may include a cavity to receive the internal electronic components and have them secured therein. A rear plate 504 may be secured to the housing 502 with suitable fasteners, or adhesives, or silicone to secure the internal components within the housing 502. As discussed above, certain internal components may be supported by one or more printed circuit board assemblies (PCBA) 506. For example, the PCBA 506 may support the Hall sensor 310, the vibration circuit 312, the LED 320, and the microcontroller 322. An additional PCBA 508 is also coupled to the PCBA 506. The PCBA 508 supports the radar motion sensor 306. The mezzanine board 508 and the radar motion sensor 306 are positioned to allow the radar to be transmitted and received through the housing 502, and in particular, through a radar transmission portion 510 of the housing 502.

The housing 502 also includes a cavity to receive the depressible button 308, which may be part of a button diaphragm assembly. As described above, the depressible button 308 may be coupled to a magnet that is displaced when the button 308 is pressed by a pedestrian. The displacement of the magnet is sensed by the Hall sensor 310 and is registered as a walk phase request. The pushbutton station 500 also includes the speaker 318 that provides the audio associated with the pushbutton sensor 500. For example, the speaker 318 may provide a locate tone, a walk message, and/or a verbal countdown associated with a clearance phase.

The pushbutton station 500 also includes a button cover 514. The button cover 514 may be secured to the housing 502 using suitable fasteners. The button cover 514 holds the button 308 within the cavity formed in the housing 502. The button cover 514 may also include a through hole to receive the LED 320. The button cover 514 may be formed of a metallic material, for example aluminum or stainless steel. Alternatively, the button cover 514 may be formed of a rigid polymeric material. The radar motion sensor 306 is positioned such that the radar transmission and reception occurs above the button cover 514, such that the button cover 514, which may be formed of a metallic material, does not block or otherwise interfere with the radar transmission and reception.

With respect to the radar motion sensor 306, such a device may include any type of radar or other detector that may be employed or altered to sense motion and/or the presence of an object in the close range detection zone 404 or the long-range detection zone 406 or any applicable area. In one embodiment, a commercially available radar sensor may be altered or tuned down to decrease the range of evaluation or detection. As an example but not by way of limitation, as persons may be positioned at varying distances from the sensor, a radar sensing device that typically senses out to a 30 foot range may be tuned down or electronically altered to sense presence of an object or motion within a range of less than ten feet, or less than five feet, or at any desired value, including but not limited to from zero to five inches from the surface of the pushbutton station 400, or from six inches up to twenty feet from the surface, or any other appropriate range. Sensing may be tuned to one foot, two feet, five feet, or any other applicable value.

The present design may also evaluate signals received from objects within the applicable detection zone and may filter or ignore “false positives.” As an example, rain or snow may trigger an indication that movement has occurred within the detection zone, or the presence of small objects being blown through the detection zone might indicate a triggering of the applicable pedestrian sequence, such as a WALK or DON'T WALK visual, audible, or tactile indication. In such situations, these “false positives” are filtered by examining, for example, size of the object and/or return signal level received, motion of the object based on radar signal received, or other applicable measurements. The expectation is that a person may place his or her hand in front of the radar sensor and/or may wave his or her hand in front of the sensor, both within the detection zone established. Objects differing in size or radar return signal magnitude from, for example, a human hand or other applicable apparatus (e.g. a cane) may be filtered or flagged as a false positive and the applicable pedestrian sequence not initialized. Further, the radar or other signal may be evaluated as to the motion of an object or objects, including velocity and/or orientation of the motion, and may remove or ignore any motion not expected under expected circumstances. Other circumstances or conditions may be filtered or flagged based on circumstances. As with all attributes or determinations made herein, values or circumstances may be changed either locally or remotely where available. For example, a remote connection may be offered to a central server or location wherein a range evaluated, including a detection zone, may be changed from a remote location from a relatively small range to a larger range. Alternately, a local or remote change may be initiated to change the duration of a WALK indication or a change in a time threshold such that a button press exceeding the time threshold results in a change of functionality.

Thus according to one embodiment, there is provided a pushbutton station, comprising a user selectable pushbutton, a housing, a radar sensor module supported by the housing operable to detect motion occurring within a detection zone, and a controller configured to receive an electronic communication transmitted from the radar sensor module. Upon receipt of the electronic communication, the controller is configured to effectuate user selectable pushbutton functionality without the selectable pushbutton having been physically selected.

Pushbutton functionality may comprise initiating a user selectable pushbutton related event or actuating a device, or an electrical contact closure. The device may be selected from the group comprising an actuatable door, a light, a door lock, and an elevator car. The design may include a visual indicator that lights to confirm the effectuation of the user selectable pushbutton functionality. An audio transmitter may be provided that provides audio to confirm the effectuation of the user selectable pushbutton functionality. The radar sensor module may include an emission surface and the detection zone may be in a range of zero to twelve inches from the emission surface. The radar sensor module may emit an electromagnetic radar wave in a range of 20 GHz to 85 GHz. An extended push duration representing a certain period of movement or a specific type of movement may effectuate the user selectable pushbutton functionality.

According to a further embodiment of the present design, there is provided a pushbutton station, comprising a user selectable pushbutton, a sensor operable to detect motion occurring within a detection zone, and a traffic controller associated with a traffic controlled intersection, the traffic controller configured to receive an electronic communication transmitted from the sensor module. Upon receipt of the electronic communication, the controller is configured to effectuate user selectable pushbutton functionality without the selectable pushbutton having been physically selected.

The sensor module may be a radar sensor module. The electronic communication may indicate a request to cross a street for a walk phase. The detection zone may be between zero feet and up to thirty feet from a surface of the pushbutton station, or between zero feet and up to six feet, or between zero feet and up to six inches. The pushbutton station may further include an audio transmitter that provides audio associated with a walk event.

According to another embodiment of the present design, a pushbutton station may be provided, comprising a user selectable pushbutton, a sensor module operable to detect motion occurring within a detection zone comprising an area a predetermined distance from the sensor module, and a controller configured to receive an electronic communication transmitted from the sensor module. Upon receipt of the electronic communication, the controller is configured to effectuate functionality of the user selectable pushbutton without the selectable pushbutton having been physically selected.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the embodiments of the pushbutton station as shown in the various exemplary embodiments is illustrative only. Additionally, any element disclosed in one embodiment may be incorporated or utilized with any other embodiment disclosed herein.

What is claimed is:

1. A pushbutton station, comprising:
a user selectable pushbutton;
a housing;
a radar sensor module supported by the housing operable to detect motion occurring within a detection zone; and
a controller configured to receive an electronic communication transmitted from the radar sensor module;
wherein upon receipt of the electronic communication, the controller is configured to effectuate user selectable pushbutton functionality without the selectable pushbutton having been physically selected.

2. The pushbutton station of claim 1, wherein the pushbutton functionality comprises initiating a user selectable pushbutton related event or actuating a device.

3. The pushbutton station of claim 1, wherein the pushbutton functionality comprises an electrical contact closure.

4. The pushbutton station of claim 1 wherein the device is selected from the group comprising an actuatable door, a light, a door lock, and an elevator car.

5. The pushbutton station of claim 1, further comprising a visual indicator that lights to confirm the effectuation of the user selectable pushbutton functionality.

6. The pushbutton station of claim 1, further comprising an audio transmitter that provides audio to confirm the effectuation of the user selectable pushbutton functionality.

7. The pushbutton station of claim 1, wherein the radar sensor module comprises an emission surface and wherein the detection zone is in a range of zero to twelve inches from the emission surface.

8. The pushbutton station of claim 1 wherein the radar sensor module emits an electromagnetic radar wave in a range of 20 GHz to 85 GHz.

9. The pushbutton station of claim 1 wherein an extended push duration representing a certain period of movement or a specific type of movement effectuate the user selectable pushbutton functionality.

10. A pushbutton station, comprising:
a user selectable pushbutton;
a sensor operable to detect motion occurring within a detection zone; and
a traffic controller associated with a traffic controlled intersection, the traffic controller configured to receive an electronic communication transmitted from the sensor module;
wherein upon receipt of the electronic communication, the controller is configured to effectuate user selectable pushbutton functionality without the selectable pushbutton having been physically selected.

11. The pushbutton station of claim 10, wherein the sensor module is a radar sensor module.

12. The pushbutton station of claim 10, wherein the electronic communication indicates a request to cross a street for a walk phase.

13. The pushbutton station of claim 10 wherein the detection zone is between zero feet and up to thirty feet from a surface of the pushbutton station.

14. The pushbutton station of claim 10 wherein the detection zone is between zero feet and up to six feet from a surface of the pushbutton station.

15. The pushbutton station of claim 10 wherein the detection zone is between zero feet and up to six inches from a surface of the pushbutton station.

16. The pushbutton station of claim 10 further comprising a further comprising an audio transmitter that provides audio associated with a walk event.

17. A pushbutton station, comprising:
a user selectable pushbutton;
a sensor module operable to detect motion occurring within a detection zone comprising an area a predetermined distance from the sensor module; and
a controller configured to receive an electronic communication transmitted from the sensor module;
wherein upon receipt of the electronic communication, the controller is configured to effectuate functionality of the user selectable pushbutton without the selectable pushbutton having been physically selected.

18. The pushbutton station of claim 17, wherein the controller comprises a traffic controller associated with a traffic controlled intersection.

19. The pushbutton station of claim 17, wherein the sensor module is a radar sensor module.

20. The pushbutton station of claim 17, wherein the predetermined distance is between zero and thirty feet.
